(19) United States
(12) Patent Application Publication
(10) Pub. No.: US 2024/0345351 A1
(43) Pub. Date: Oct. 17, 2024

(54) PRE-TERMINATED CROSS-CONNECT SYSTEM

(71) Applicant: viaPhoton, Inc., Aurora, IL (US)

(72) Inventors: Nathan Eric BENTON, Dallas, TX (US); Walter Mark HENDRIX, Dallas, TX (US); Jeffrey Earl JONES, SR., Stewartstown, PA (US); Mark James SMRHA, Chicago, IL (US); Joshua Wayne TOD, Scottsdale, AZ (US)

(21) Appl. No.: 18/633,655

(22) Filed: Apr. 12, 2024

Related U.S. Application Data
(60) Provisional application No. 63/458,862, filed on Apr. 12, 2023.

(51) Int. Cl. G02B 6/44

(52) U.S. Cl. CPC G02B 6/4452; G02B 6/44528

(57) ABSTRACT

An apparatus comprises a trunk connector array and a cross connect module. The trunk connector array comprises a plurality of trunk cable connectors. The cross-connect module houses a plurality of patch connectors, wherein the plurality of patch connectors terminate the plurality of trunk cable connectors.

### CROSS REFERENCE TO RELATED APPLICATIONS

This application claims the benefit of U.S. Provisional Application 63/458,862, filed Apr. 12, 2023, which is incorporated by reference herein.

### BACKGROUND

Telecommunications equipment includes racks and panels used in the management and organization of optical fibers. Optical fibers are thin, flexible strands of glass or plastic that transmit data as light signals. These fibers are widely used for high-speed data transmission, enabling efficient communication networks. Racks and panels serve as the physical framework for these optical fibers, providing support and protection while ensuring a structured layout within telecommunication systems.

Racks skeletal framework upon which various telecommunication components are mounted. Panels are fixtures designed to be mounted within the rack to accommodate optical fibers to facilitate the flow of data signals through a telecommunications network. The arrangement of fibers within these panels takes care to maintain signal integrity and prevent signal loss for the efficient functioning of telecommunication networks.

A challenge with telecommunications equipment is the low densities of fibers within the panels. Low fiber densities in these panels hamper the scalability and efficiency of telecommunication systems.

### SUMMARY

According to embodiments of the invention, an apparatus is provided comprising a trunk connector array and a cross connect module. The trunk connector array comprises a plurality of trunk cable connectors. The cross-connect module houses a plurality of patch connectors, wherein the plurality of patch connectors terminate the plurality of trunk cable connectors.

### BRIEF DESCRIPTION OF DRAWINGS

FIG. 1 shows a rack according to illustrative embodiments.

FIG. 2A and 2B show a cross-connect module according to illustrative embodiments.

FIG. 3 shows a cross-connect rack including multiple cross-connect modules according to illustrative embodiments.

FIG. 4 shows a cross-sectional image of a cross-connect module according to illustrative embodiments.

FIG. 5 shows a cross-sectional image of a cross-connect module with splicing option according to illustrative embodiments.

FIG. 6 shows cross-connect modules secured in a side-by-side configuration according to illustrative embodiments.

FIGS. 7A and 7B show cross-connect modules secured in a back-to-back configuration according to illustrative embodiments.

FIGS. 8A, 8B, and 8C show different configurations of cross-connect modules mounted on a rack, according to illustrative embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the disclosure address the challenges of low fiber density by providing high density fiber panel organization. High fiber density may be achieved using modules within the panels. High fiber count in this sense can include single datacenter rack systems that have from 5000 to more than 13000 fiber connections.

The modules described herein significantly reduce installation time include factory (not field) pre-termination of optical connections, pre-assembly of optical cross-connect subsystems, and testing of both. The modules include an aspect ratio between the height and width of the module that is close to 1 (e.g., in the range of 1.25 to 0.75). The module includes multiple ports that may each secure multiple fibers. The embodiments described herein provide novel approaches to reducing the labor required to install and evaluate optical cross-connect systems for high fiber count datacenter applications.

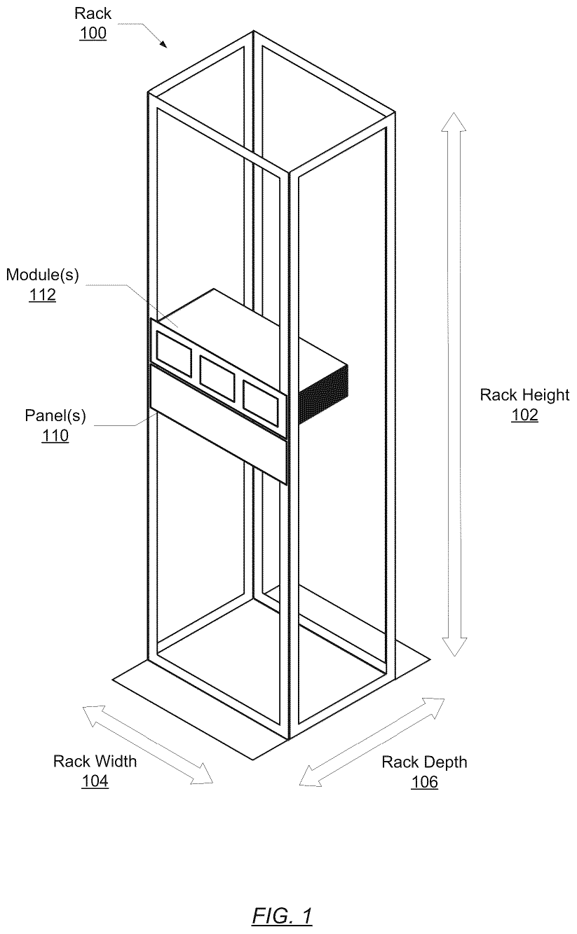

Turning to FIG. 1, a rack is shown according to illustrative embodiments. The rack (100) is a piece of telecommunications equipment that provides a standardized, efficient, and secure solution for the housing and organization of diverse telecommunication devices. The design of the rack (100) provides compatibility, stability, proper ventilation, and streamlined cable management.

The rack may include a sturdy, rectangular frame crafted from durable materials, designed to facilitate the systematic arrangement and secure mounting of various telecommunication devices and components. The outer dimensions of rack (100), including rack width (104) and rack depth (106), aligns with the widths of most network and server equipment. For example, rack width (104) may measure 19 inches (48.26 cm) or 23 inches (58.42 cm) in width, standard measurements that are adhered to in the telecommunications industry. Other dimensions may be used, e.g., 21 inches, 23 inches, etc. The rack height (102), and rack width (104), and rack depth (106) dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear. The slots of the rack (100) serve as attachment points for mounting the panel(s) (110) associated with telecommunication equipment. The standardized spacing between the slots of the rack (100) ensures compatibility with a wide array of telecommunication devices, allowing for seamless integration and easy replacement.

Each mounting slot of the rack (100) may be equipped with fastening mechanisms, enabling the fixation of mounting brackets and panels in a secure and stable manner. The utilization of these mechanisms ensures that the mounted equipment remains firmly in place, even during transportation or in environments with vibrations.

The rack (100) may further be equipped with ventilation openings strategically positioned on the front and rear of the rack (100). The ventilation openings promote adequate airflow within the rack, preventing the accumulation of heat and ensuring optimal operating conditions for the housed telecommunication equipment. Ventilation may contribute to the overall longevity and reliability of the installed devices.

The rack (100) may be designed to facilitate cable management. The rack (100) may incorporate integrated cable routing features, such as cable tie points and channels, which enable the organized routing and bundling of cables connected to the telecommunication equipment. The cable management provided by the rack (100) may enhance the aesthetic design of the rack (100) and simplify maintenance tasks by providing clear pathways for troubleshooting and repairs.

The panel(s) (110) are structured to fit to the rack (100). Panel(s) (110) are flat, rectangular components that mount within the rack (100) to organize, secure, and provide access to connective hardware. The panel(s) (110) may serve as an interface for cable connections and can include features such as cable management systems to maintain cable bend radius, labels for port identification, and grounding points for electrical safety. The panel(s) (110) may be configured as patch panels, blanking panels, or connector panels and are typically built from durable materials such as metal or high-grade plastics. The panel(s) (110) may include standardized mounting points to align with rack units, a layout that supports the intended cable or connector density, and provisions for labeling and user accessibility.

The panel(s) (110) may be fiber interconnection panels structured to support and secure optical fibers and cables. The panel(s) (110) facilitate the organized interconnection of optical components, ensuring reliable and efficient transmission of optical signals.

The panel(s) (110) are formed with standardized form factors for compatibility with the mounting slots of the rack (100). The panel(s) (110) may be equipped with one or more module(s) (112) to secure the fibers using ports, connector adapters, connectors, etc. The ports are strategically arranged within the module(s) (112) and the panel(s) (110) to allow for the efficient insertion and termination of optical fiber cables by inserting connectors into the connector adapters.

The panel(s) (110) may incorporate integrated cable management features. The cable management features may include cable routing channels, loops, and strain relief mechanisms. Optical fiber cables may be organized and secured using the cable management features to minimize cable stress and prevent signal degradation due to bending or twisting.

A front surface of each of the panel(s) (110) may include labeling options, allowing for clear identification of individual fiber connections. Proper labeling enhances efficient troubleshooting, maintenance, and future expansions by providing reference points for specific optical pathways.

The module(s) (112) fit to the panel(s) (110) and support the fibers. Module(s) (112) are prefabricated units or sub-assemblies designed for quick installation into the rack (100). The module(s) (112) may house electronic components, such as switches, routers, or patch panels, and are tailored to specific applications, facilitating scalability and ease of maintenance. The module(s) (112) may include features such as hot-swap capability.

The module(s) (112) are commonly constructed with a rigid metal or plastic frame to protect internal components and are compatible with rack dimensions. The module(s) (112) may incorporate connectors, LEDs, or other indicators for status monitoring. The module(s) (112) may include suitable interfaces for power and data connectivity, and compliance with industry standards for electromagnetic compatibility and safety. The module(s) (112) may include features for splicing, cable management, and security. Each of the module(s) (112) may include a group of the connector adapters to accommodate several types of optical connectors, such as LC connectors, SC connectors, ST connectors, etc.

The front end of the module(s) (112) is exposed through the front of one of the panel(s) (110) and through the front of the rack (100). The front end of the module(s) (112) includes the connector adapters.

The height of the module(s) (112) conforms to the standard dimensions of a 1 RU. In other embodiments, the height of module(s) (112) may be a multiple the standard 1 RU dimension, e.g., 2 RU, 3 RU, etc. Using the 1 RU height provides for integration and compatibility within the standardized space, optimizing vertical rack utilization in telecommunication installations.

The width for each of the module(s) (112) may enable a group of the module(s) (112) to fit within one of the panel(s) (110). For example, the width of each module(s) (112) may be selected such that a number of modules (e.g., 4, 6, 8, 10, 12, etc.) can be accommodated within the rack width (104).

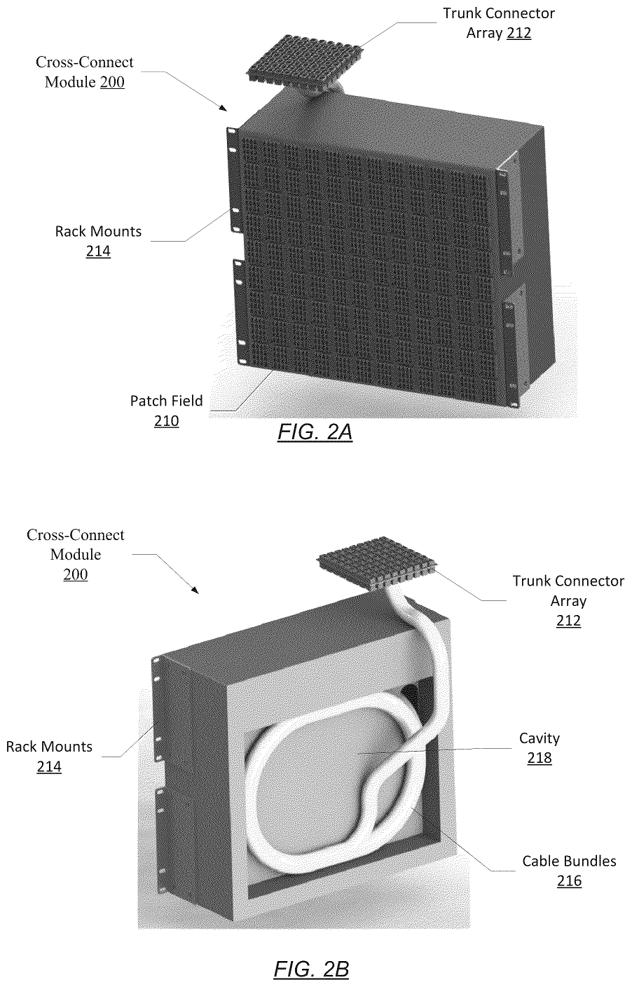

Turning to FIG. 2A and 2B, a cross-connect module (200) is shown according to illustrative embodiments. Cross-connect module (200) serves as a connection point between cabling runs, subsystems, and equipment using patch cords and/or jumpers that attach to connecting hardware on each end. Cross-connect module (200) is an example of module(s) (112) of FIG. 1.

The cross-connect module (200) is a self-contained unit engineered to facilitate the organization and management of fiber optic connections. The cross-connect module (200) may feature an array of ports or adapters for various connector types, such as LC, SC, or MTP, and may be built to accommodate high-density fiber counts to maximize space efficiency in data center environments.

The patch field (210) is an organized array of connectors systematically arranged to facilitate the cross-connection of optical fibers within a pre-terminated module. The patch field (210) serves as a centralized interface where individual fiber optic patch cords are connected, providing organized and accessible connections between incoming and outgoing optical fibers. The patch field (210) consists of an array of ports or adapters that accommodate fiber optic connectors.

Each patch field accommodates a series of fiber subunits, where a singular fiber subunit can house multiple fiber connections. As illustrated, patch field (210) features a configuration of 12 subunits per 1 RU row, with each subunit containing 16 LC optical fiber connectors. The patch field (210) is organized into 9 rows, totaling 1728 fiber connections. Other subunits may accommodate different fiber counts, such as 12 to 36 fibers, using connectors appropriate for the fiber density.

The trunk connector array (212) is a fiber optic interface component designed to consolidate multiple optical connections into a single, manageable unit. The trunk connector array (212) provides a multi-fiber connector assembly for interconnecting multiple optical fibers, such as in a trunk cable, with corresponding ports or adapters on cross-connect module (200).

The trunk connector array (212) may support various multi-fiber connector types, such as MPO or MTP, utilizing a high-density arrangement of connectors that facilitate rapid deployment of fiber network infrastructure, enabling simultaneous multiple fiber connections with each insertion. For example, in some embodiments, the trunk connector array (212) comprises a configuration of 72 Multi-fiber Push On (MPO) connectors, each capable of housing 24 individual optical fibers, effectively bringing together a total of 1728 fibers.

The cross-connect module (200) may include one or more Rack Mounts (214). The Rack Mounts (214) are structural fixtures designed to secure the cross-connect module (200) to a standard equipment rack, such as rack (100) of FIG. 1. The Rack Mounts (214) may be aligned with the universal hole pattern on equipment racks, which conforms to EIA/TIA standards for spacing and dimensions.

Cavity (218) is a recessed space located on the rear surface of the cross-connect module (200). The Cavity (218) is reserved for organizing and routing fiber optic cables and cable bundles, providing strain relief and slack management to the cable bundles (216). The Cavity (218) may be shaped to optimize space usage within the module while allowing for ease of access for cable installation or maintenance. In some embodiments, the cavity (218) includes features such smooth surfaces to prevent abrasion of fiber jackets, anchoring points for cable ties or Velcro straps, and raceway guides to maintain appropriate bend radii without causing undue stress or compression on the fibers.

The cable bundles (216) are groups of optical fibers that are bound together for organized routing through the cross-connect module. These bundles may be encased within a common jacket to form a single manageable unit.

The cable bundles (216) form a pre-terminated optical interconnect between the trunk connector array (212) and the patch field (210). In other words, each of these connections is completed and evaluated prior to installation of the cross-connect module (200) at a datacenter.

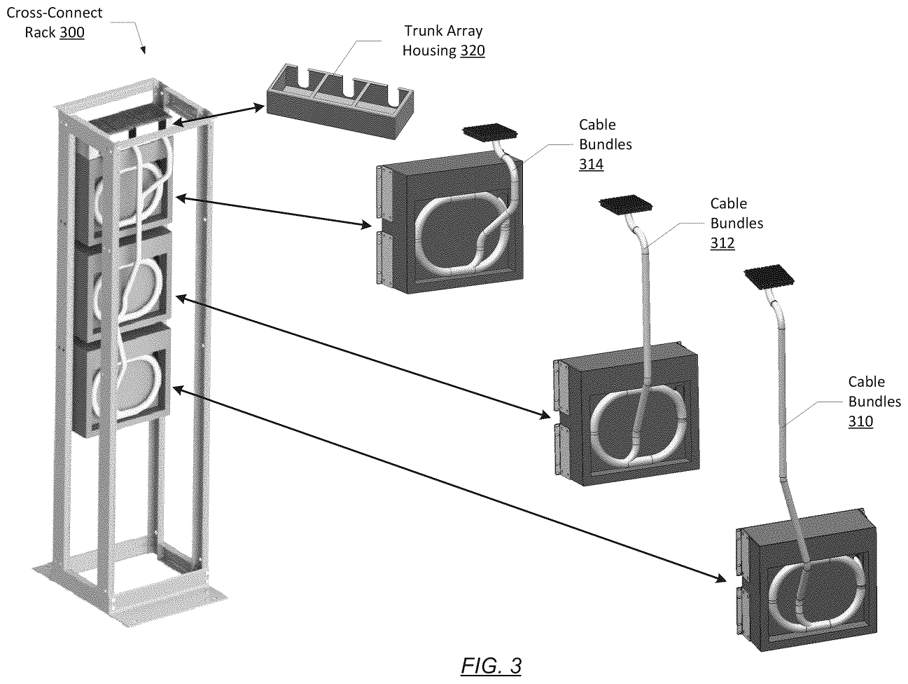

Turning to FIG. 3, a cross-connect rack (300) is shown including multiple cross-connect modules secured to the rack, according to illustrative embodiments.

The cross-connect rack (300) serves as a vertical mounting structure for multiple cross-connect modules, each connected to the trunk connector array (212) through cable bundles (310, (312), and (314). Excess lengths of cable bundles (310, (312), and (314) are effectively managed within the recess of respective modules in a manner that preserves the cable's integrity and performance.

Trunk connector arrays from the various modules can be secured within trunk array housing (320), mounted at the top of cross-connect rack (300). This system ensures that the cables are not only correctly positioned but also easily accessible for maintenance or reconfiguration while keeping the rack environment uncluttered and systematically organized.

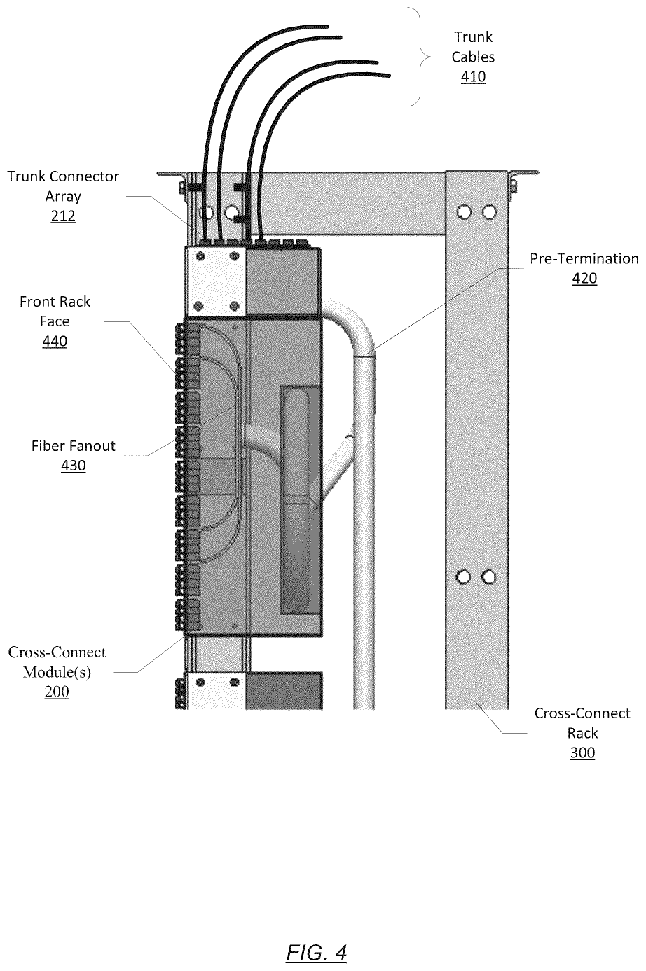

Turning to FIG. 4, a cross-sectional image of a cross-connect module is shown, according to illustrative embodiments. The cross-connect module is an example of cross-connect module (200) of FIG. 2.

The cross-connect module (200) interfaces with trunk cables (410) via the trunk connector array (212). The trunk cables (410) enter the cross-connect module, transitioning into cable bundles (216) via the trunk connector array (212). Individual fibers of the cable bundles (216) are segregated and directed towards their respective termination points within the module at fiber fanout (430).

Within the module, fiber connections between the trunk connector array (212) and front rack face (440) are factory-terminated as indicated at pre-termination (420). each of these connections may be completed and evaluated prior to installation of the cross-connect module (200) at a datacenter, thereby streamlining the installation process.

The front rack face (440) provides a structured interface for the module, the patch field of front face, i.e., patch field (210) of FIG. 2, is equipped with ports or adapters to receive the fibers from the fiber fanout (430), aligning fibers in an orderly manner and ensuring that connections are easily reachable for maintenance or adjustment.

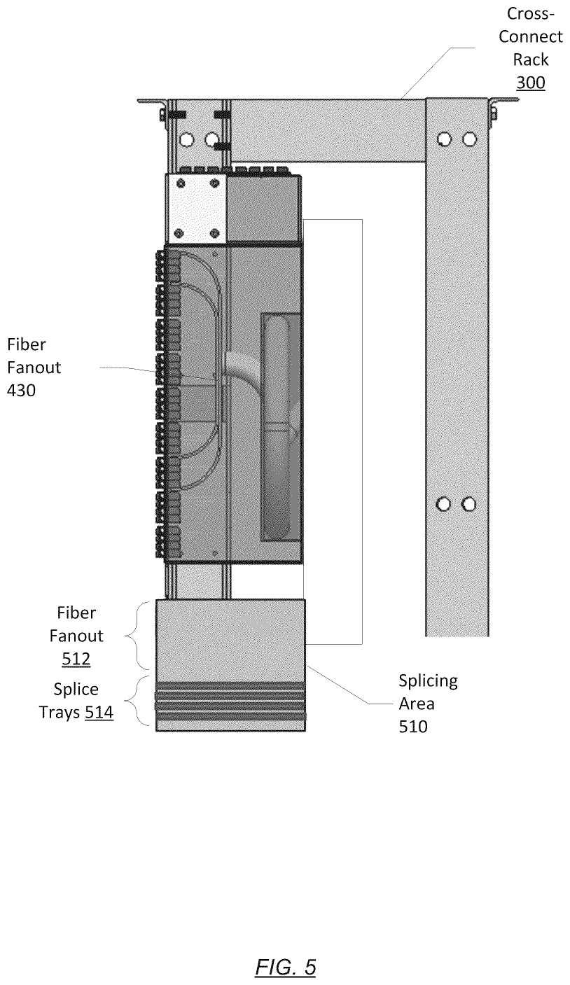

Turning to FIG. 5, a cross-sectional image of a cross-connect module with splicing option is shown, according to illustrative embodiments. The cross-connect module is an example of cross-connect module (200) of FIG. 2.

Splicing area (510) is designed as a space within the cross-connect module where individual optical fibers can be spliced after being routed through the fiber fanout (430).

The individual fibers are separated and routed the towards the splice trays (514) at Fiber Fanout (512), ensuring that each fiber is laid out in an approachable manner without excessive bending or tension. the splice trays (514) provide an organized platform for housing spliced fibers, protecting the delicate spliced junctions and maintaining an orderly cable management system. the splice trays (514) may be stacked for easy access to each splice for inspection or reconfiguration.

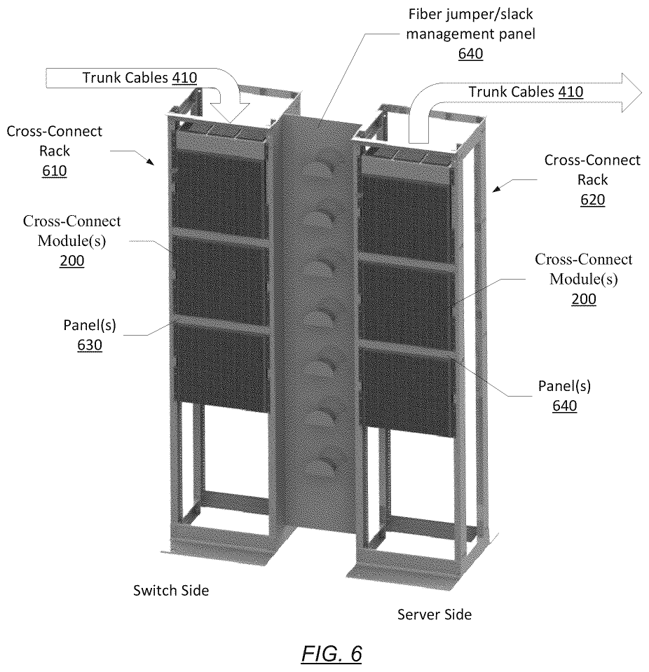

Referring now to FIG. 6, cross-connect racks (610, 620) include the cross-connect modules secured to the cross-connect racks (610, 620) in a side-by-side configuration so that the patch connectors of the patching fields of the cross-connect modules (202) face the same direction.

A side-by-side configuration of two Cross-connect racks (610, 620) may facilitate efficient cable management and connectivity within a network infrastructure. Each of the cross-connect racks (610, 620) may support one or more of the multiple cross-connect module (200) that house and organize network connections. The side-by-side configuration is designed such that the patch connectors of the patch fields within these modules all face in the same direction, optimizing ease of access and promoting organized cable routing.

A Fiber Jumper/Slack Management Panel (640) may be positioned between the two Cross-connect racks (610, 620). Fiber Jumper/Slack Management Panel (640) provides a structured and accessible means for handling excess fiber lengths, and ensuring that minimum bend radius requirements are met.

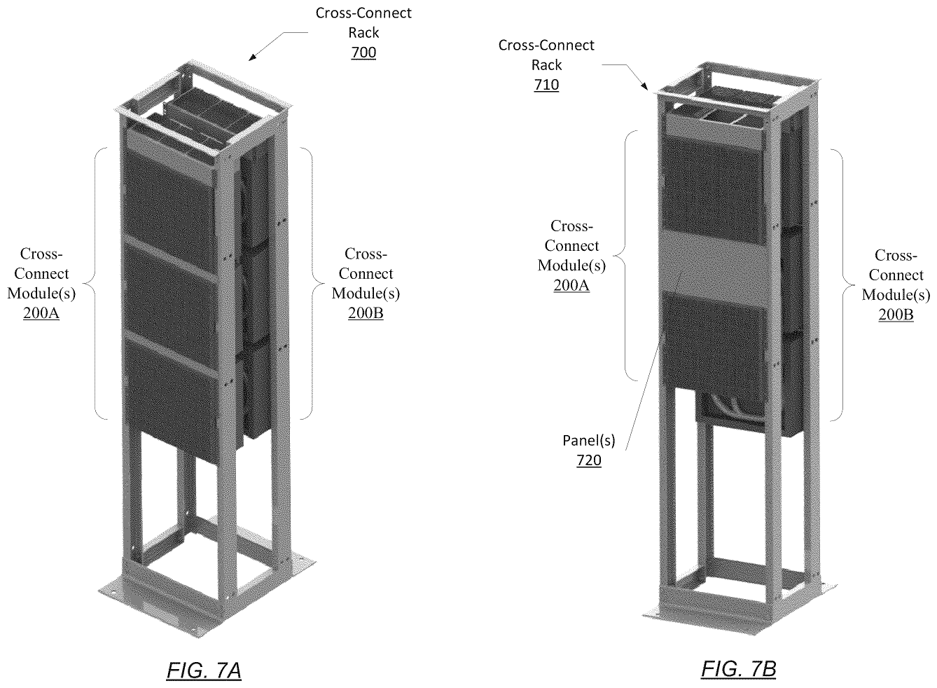

Turning to FIGS. 7A and 7B, the cross-connect racks (700, 710) include the cross-connect modules secured to the cross-connect racks (700, 710) in a back-to-back configuration to reduce a footprint of the cross-connect racks (700, 710).

Referring specifically to FIG. 7A, cross-connect rack (700) is a back-to-back configuration, supporting two types of cross-connect modules, designated as (200A, 200B). cross-connect module (200A) is visible from the front, while cross-connect module (200B) is mounted on the rear side of the rack. This configuration optimizes the spatial economy by positioning the modules such that their patching fields face in opposite directions, a design that diminishes the rack's physical footprint within the facility. By placing modules back-to-back, both sides of the rack are utilized effectively, doubling the potential connectivity without extending into the data center's valuable floor space. This arrangement may be beneficial for segregating different traffic types or network domains while maintaining a centralized management point.

In FIG. 7B, cross-connect rack (710) is structured to accommodate cross-connect modules (200A, 200B) in a back-to-back configuration. Panel(s) (720) are positioned in between the modules, functioning as a partition that aids in the organization of cables and maintaining separation of different network segments. Panel(s) (720) may also be utilized for slack management, storing excess cable lengths, and maintaining the bend radius of cables.

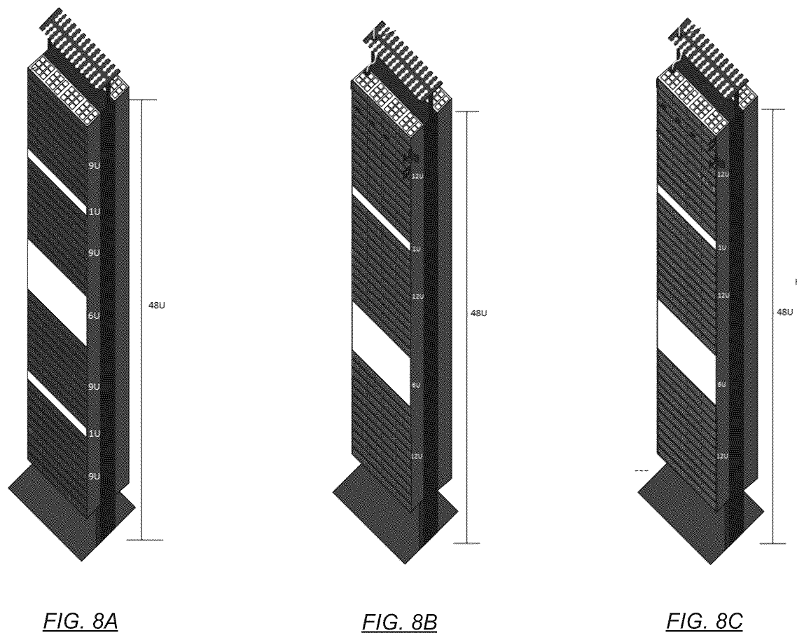

FIGS. 8A, 8B, and 8C show different configurations of cross-connect modules mounted on a rack, according to illustrative embodiments. The entire configuration is designed to fit within a standard rack sizing convention, here indicated as 48 U in total height.

FIG. 8A is a first rack configuration designed to manage a large fiber count, for example 13,824 fibers. The rack includes four cross-connect modules, each occupying 9 rack units (9 U) in height. These cross-connect modules facilitate the organization and distribution of 192 fibers per 1 U panel, or 1,728 fibers per block, streamlining the management of the extensive fiber count. An MPO (Multi-fiber Push On) bank consisting of 12 ganged MPO16 connectors, is pre-terminated to the panels,

A 1 U spacer is provided beneath each 9 U cross-connect module, providing necessary space for airflow, cable routing, or access for maintenance activities. A 6 U space may be dedicated to a splice panel, used if the fibers are not pre-terminated. A 4 U unused space may be reserved for future expansion, additional components and/or functional enhancements.

FIG. 8B is a second rack configuration designed to accommodate 10,368 optical fibers. The rack comprises three 12 U sections, each housing cross-connect modules to manage the connections. Each cross-connect module is designed to manage a high density of fibers, with 144 fibers per panel (1,728 fibers per block). 1 U spacers are provided between blocks to assist with cable management and airflow. A 6 U space may be dedicated to a splice panel, with an unused 5 U space reserved for future expansion, additional components and/or functional enhancements.

FIG. 8C is a third rack configuration designed to accommodate 6,912 optical fibers. The rack comprises three 12 U sections, each housing cross-connect modules to manage the connections. Each cross-connect modules is designed to manage a high density of fibers, with 96 fibers per panel (1,152 fibers per block). 1 U spacers are provided between blocks to assist with cable management and airflow. A 6 U space may be dedicated to a Splice Panel, with an unused 5 U space reserved for future expansion, additional components and/or functional enhancements.

The term “about,” when used with respect to a physical property that may be measured, refers to an engineering tolerance expected by or determined by one of ordinary skill in the art. The exact quantified degree of an engineering tolerance depends on the product being produced, the process being performed, or the technical property being measured. For a non-limiting example, two angles may be “about congruent” if the values of the two angles are within ten percent of each other. However, if the ordinary artisan determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A could have been separate from component B, but is joined to component B in either a fixed or a removably attached arrangement. In a second meaning, unless otherwise stated, “connected to” means that component A is integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such, includes the term “and.” Further, items joined by the term “or” may include any combination of the items with any number of each item, unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising:
a trunk connector array comprising a plurality of trunk cable connectors; and
a cross-connect module housing a plurality of patch connectors, wherein the plurality of patch connectors terminate the plurality of trunk cable connectors.

2. The apparatus of claim 1, wherein the cross-connect module further comprises:
a cavity supporting a plurality of optical fibers between the plurality of trunk cable connectors and the plurality of patch connectors.

3. The apparatus of claim 1, wherein the cross-connect module comprises a plurality of ports configured to receive optical fiber connectors.

4. The apparatus of claim 1, wherein the trunk connector array comprises ganged MPO connectors pre-terminated to the cross-connect modules.

5. The apparatus of claim 1, further comprising:
a rack structured to house telecommunication components.

6. The apparatus of claim 3, wherein the apparatus is secured to the rack in a side-by-side configuration.

7. The apparatus of claim 3, wherein the apparatus is secured to a rack in a back-to-back configuration.

8. The apparatus of claim 5, further comprising:
a spacer positioned on the rack to facilitate airflow and cable routing between the cross-connect module.

9. The apparatus of claim 1, further comprising:
cable management features integrated within the rack to organize optical fibers connected to the cross-connect module.

10. The apparatus of claim 9, wherein the cable management features include integrated cable routing channels and tie points.

11. A method for managing optical fibers in a data center, the method comprising:
providing a rack structured to house telecommunication components:
mounting an apparatus to the rack, wherein the apparatus comprises:
a trunk connector array comprising a plurality of trunk cable connectors; and
a cross-connect module housing a plurality of patch connectors, wherein the plurality of patch connectors terminate the plurality of trunk cable connectors; and
organizing optical fibers using the rack.

12. The method of claim 11, further comprising:
supporting, in a cavity of the cross-connect module, a plurality of optical fibers between the plurality of trunk cable connectors and the plurality of patch connectors.

13. The method of claim 11, wherein the cross-connect module comprises a plurality of ports configured to receive optical fiber connectors.

14. The method of claim 11, wherein the trunk connector array comprises ganged MPO connectors pre-terminated to the cross-connect modules.

15. The method of claim 11, further comprising:
mounting a plurality of apparatuses to the rack in a side-by-side configuration.

16. The method of claim 11, further comprising:
mounting a plurality of apparatuses to the rack in a back-to-back configuration.

17. The method of claim 11, further comprising:
positioning a spacer on the rack to facilitate airflow and cable routing between the cross-connect module.

18. The method of claim 11, further comprising:
organize optical fibers connected to the cross-connect module with cable management features integrated within the rack.

19. The method of claim 18, wherein the cable management features include integrated cable routing channels and tie points.
